(19) United States
(12) Patent Application Publication
(10) Pub. No.: US 2007/0022299 A1
(43) Pub. Date: Jan. 25, 2007

(54) Password authentication device, recording medium which records an authentication program, and authentication method

(75) Inventor: Sachiko Yoshimura, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/161,046

(22) Filed: Jul. 20, 2005

(51) Int. Cl. H04L 9/00; H04K 1/00

(52) U.S. Cl. 713/183; 713/184

(57) ABSTRACT

A password authentication device is disclosed which authenticates the identity of an individual who is attempting to use a digital device, and includes authentication means and input acceptance/rejection means. The authentication means compares a text string input from an input means with a plurality of registered passwords in order to perform authentication, and determines, each time one character of the text string is input, whether or not the text string matches one of the plurality of registered passwords. The input acceptance/rejection means allows input of the next character of the text string from the input means if the authentication means identifies a match, and randomly determines whether to accept or reject input of the next character from the input means if the authentication means does not identify a match.

### BACKGROUND OF THE INVENTION

1. Field of the Invention

The present invention relates to a password authentication device, and more particularly to a password authentication device for authenticating the identity of an individual who is attempting to use a digital device.

In addition, the present invention relates to a storage medium that stores an authentication program that will be executed by the password authentication device, and an authentication method.

2. Background Information

Normally, a password authentication device grants rights to a user when the user correctly inputs both a user name and a password. However, it is extremely time consuming for an administrator to administer user registration, the granting of rights, and the like for each individual user by means of user names and passwords.

Therefore, the administration of different levels of rights for each user is conventionally performed using passwords alone. The term “different levels of rights” refers to, for example, the difference in the level of rights between those of general users and those of an administrator who administers the general users. User passwords and administrator passwords are examples of passwords with different levels of rights.

However, with the aforementioned password authentication device, if a general user coincidentally registers a user password which is identical to a pre-registered administrator password, the password authentication device will not be able to determine whether the login is for an administrator or a general user during authentication, and administrator rights will inadvertently be granted to the general user.

Therefore, in order to prevent the aforementioned problem, the use of an administrator password with more characters than that which can be registered by a user as a user password has been proposed in Japanese Patent Application Publication No. 2003-8801 and Japanese Patent Application Publication No. 2002-365980.

However, in the aforementioned prior art references, the administrator must be able to input all of the characters of the administrator password into an input device, and therefore a general user can easily learn that an administrator password has more characters than their own password.

In view of the foregoing, an object of the present invention is to make it difficult to guess a registered password by determining, each time a character of a text string is input, whether or not the text string matches one of a plurality of registered password, and randomly accepting or rejecting input of the next character of the text string when there is no match. This invention addresses this object as well as other objects, which will become apparent to those skilled in the art from this disclosure.

### SUMMARY OF THE INVENTION

The password authentication device of the present invention is used for authenticating the identity of an individual who is attempting to use a digital device, and comprises authentication means and input acceptance/rejection means.

The authentication means compares a text string input from an input means with a plurality of registered passwords in order to perform authentication, and determines, each time one character of the text string is input, whether or not the text string matches one of the plurality of registered passwords. The input acceptance/rejection means allows input of the next character of the text string from the input means if the authentication means has identified a match, and randomly determines whether to accept or reject input of the next character of the text string from the input means if the authentication means does not identify a match.

Thus, by determining whether or not a text string matches one of a plurality of registered passwords each time a character of the text string is input, and randomly accepting or rejecting input of the next character when there is no match, it will be difficult for a person to guess a registered password.

In addition, the input acceptance/rejection means may be activated each time a character is input after a predetermined number of characters have been input.

Thus, because the input acceptance/rejection means will be activated each time a character of the text string is input after a predetermined number of characters (e.g., the number of characters in a user password) are input, it will be difficult for a person to guess a registered password having higher-level rights.

In addition, the password authentication device may further comprise input conclusion means that will measure the input time from the point at which each character of the text string is input until the point at which the next character thereof is input, and will recognize that the input of the text string is complete when the input time is equal to or greater than a predetermined period of time.

Thus, because the input will be recognized as being complete when the input time exceeds a predetermined amount of time, the ease of password input will improve. Note also that the input conclusion means may, for example, be activated each time a character in a text string is input after a predetermined number of characters are input, or may be activated each time one character in a text string is input.

Furthermore, the authentication means may also determine whether or not the number of characters in a text string has reached a predetermined maximum permitted number of characters.

In addition, at least one of the plurality of registered passwords may be a user password having a predetermined number of characters.

Moreover, at least one of the plurality of registered password may be an administrator password having a level of authority that is different than that of the user password, and each administrator password may include a first password having the same predetermined number of characters as the user password and a second password appended to the first password having a different predetermined number of characters than that of the user password.

Thus, it will be possible to distinguish whether the authentication specifies a general user, or whether the authentication specifies a user (such as an administrator) with a higher level of rights.

A storage medium of the present invention stores an authentication program thereon which is executed by a computer in which a password authentication device is provided, the authentication program causing the computer to function as authentication means and input acceptance/rejection means. The authentication means compares a text string input from an input means with a plurality of registered passwords in order to perform authentication, and determines, each time one character of the text string is input, whether or not the text string matches the registered password. The input acceptance/rejection means allows input of the next character of a text string from the input means if the authentication means identifies a match, and randomly determines whether to accept or reject input of the next character of a text string from the input means if the authentication means does not identify a match.

An authentication method of the present invention is performed in an authentication device, and comprises an authentication step and an input acceptance/rejection step. In the authentication step, the authentication means compares a text string input from an input means of a digital device with a plurality of registered passwords in order to perform authentication, and determines, each time one character of the text string is input, whether or not the text string matches one of the plurality of registered password. In the input acceptance/rejection step, the input acceptance/rejection means allows input of the next character in the text string from the input means if the authentication means identifies a match, and randomly determines whether to accept or reject input of the next character from the input means if the authentication means does not identify a match.

By determining whether or not a text string matches one of the plurality of registered passwords each time a character of the text string is input, and randomly accepting or rejecting input of the next character of the text string when there is no match, it will be difficult for a person to guess a registered password.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a functional block diagram of a password authentication device of an embodiment of the present invention;

FIG. 2 is a flowchart showing the operation of a password authentication device of an embodiment of the present invention;

FIG. 3 is a schematic functional block diagram of an image forming device in which the present invention is employed; and

FIG. 4 shows specific examples of registration passwords.

### DETAILED DESCRIPTION OF THE PREFERRED EMBODIMENTS

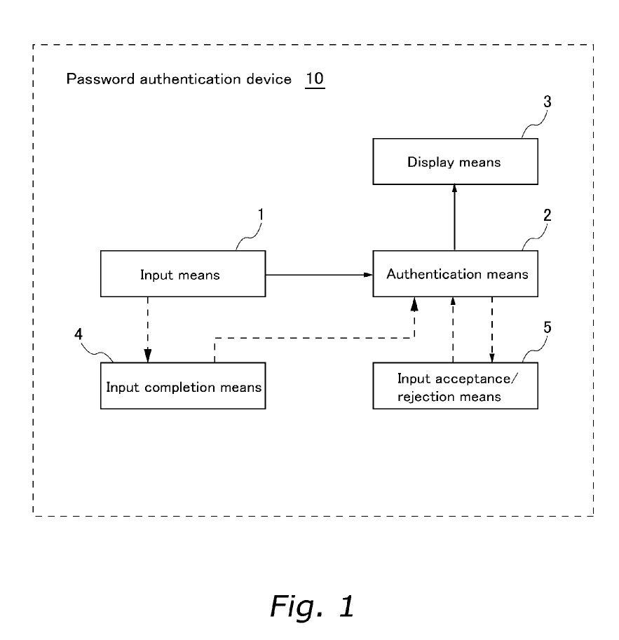

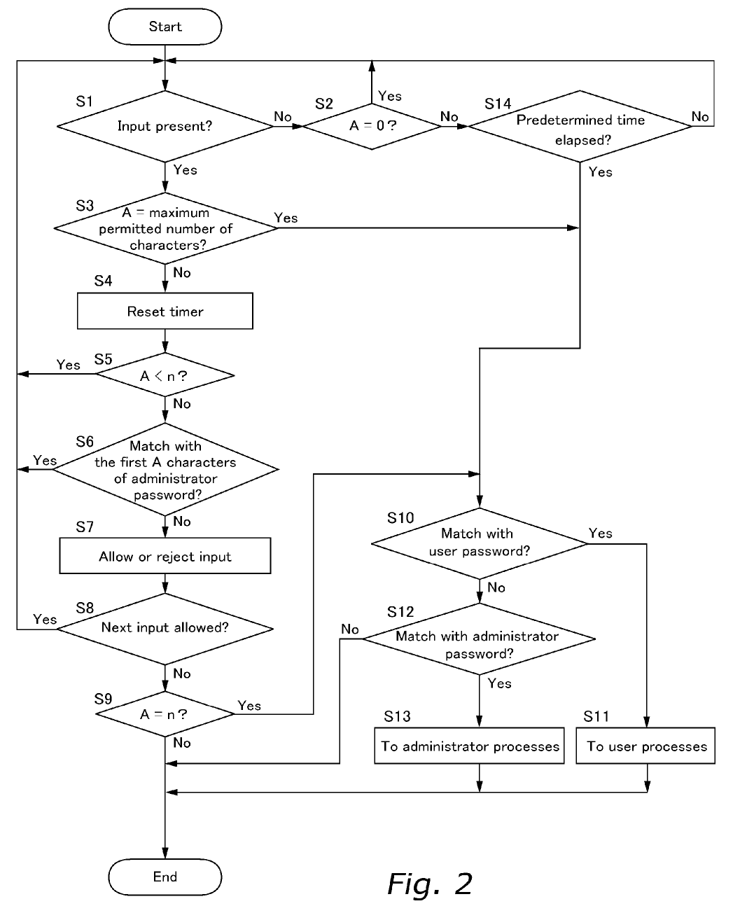

FIG. 1 is a schematic functional block diagram of a password authentication device 10 of one embodiment of the present invention, and FIG. 2 is a flowchart showing the operation of the password authentication device 10 of one embodiment of the present invention.

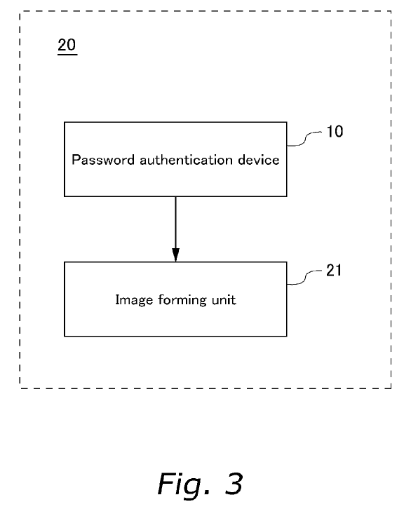

For example, as shown in FIG. 3, if a password authentication device 10 is built into an image forming device 20 such as a copy machine or the like, the user can enter a password from an input means 1 comprising operation keys, a touch panel, or the like, and if authentication of the text string is successful, the copying parameters, copying instructions, or the like will be sent to the image forming unit 21 from the input means 1.

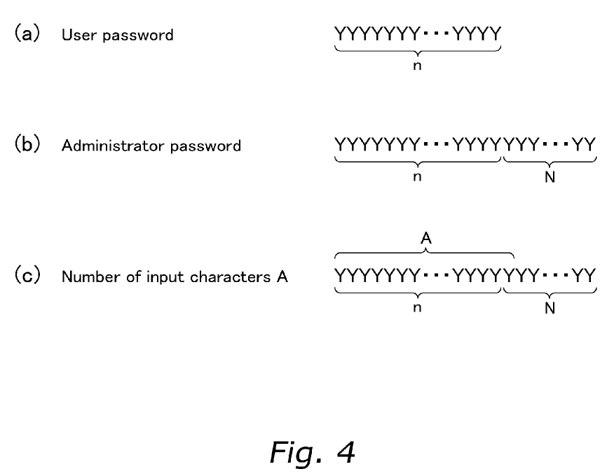

With the password authentication device 10, a plurality of registered passwords which identify at least one user and at least one administrator are stored in advance in the authentication means 2 via the input means 1. In the present embodiment, as shown in FIG. 4 (a), one or more passwords having n characters are registered as user passwords. As shown in FIG. 4 (b), one or more administrator passwords which grant a higher level of rights have N characters in addition to n characters, and therefore have a total of (n+N) characters. Furthermore, a predetermined maximum permitted number of input characters M is preset in the authentication means 2 in order to prevent the input of a text string having no limit. Here, (n+N)<M.

A user will input a text string via the input means 1. In the present embodiment, as shown in FIG. 4 (c), the number of characters in a text string that will be input is, for example, equal to A (A is less than or equal to M).

Note that as used herein, the term “text string” is defined to mean any combination of numbers, letters, symbols, or other graphical representations.

The value of each of the characters input is stored in the authentication means 2, and the text string is displayed to the user via a display means 3 that comprises a touch panel or the like. In addition, using the input means 1, the user will pre-set a timer built into an input completion means 4 with a predetermined period of time (e.g., 1 second), during which the input of the second and subsequent characters of the text string will be permitted.

The operation of the password authentication device 10 of the present invention will be described in detail below in accordance with FIG. 2.

When a password input screen is displayed on the display means 3 by which a person is able to enter a password, the authentication means 2 will determine whether or not an entry was made from the input means 1 (S1).

In the event that there is no input in step S1, i.e., A=0, the password authentication device 10 will wait in a state in which the password input screen is displayed in the display means 3 until the first character of a text string is input (S2 to S1).

In addition, each time it is determined that a character has been input in step S1, the authentication means 2 will determine whether or not the number of input characters A up to that point has reached the maximum permitted number of input characters M (S3).

In step S3, if the maximum permitted number of input characters M has been reached, the authentication means 2 will determine whether or not the value of each of the characters in the text string match a registered user password (S3 to S10).

If there is a match in step S10, authentication as a user will be successful and user processes will be enabled in the image forming device 20 (S11).

On the other hand, if there is no match in step S10, the authentication means 2 will determine whether or not the values of each character in the text string match an administrator password (S10 to S12).

If there is a match in step S12, authentication as an administrator will be successful and administrator processes will be enabled in the image forming device 20 (S13).

In addition, if there is no match in step S12, the password authentication process will be terminated.

On the other hand, if the maximum permitted number of input characters M has not been reached in step S3, the input of additional characters will be possible, and thus each time a character is input after the first character, the timer built into the input completion means 4 will be reset (S4), and the time until the input of the next character will be measured.

When the aforementioned timer is reset, the authentication means 2 will determine whether or not the number of input characters A is less than the number of characters n in a registered user password (S5).

In step S5, if the number of input characters A is less than the number of characters n in a user password, the process will move to step S1, and it will be determined whether or not there a character has been input from the input means 1 (S5 to S1).

On the other hand, in step S5, if the number of input characters A is equal to or greater than the number of characters n in a user password, the authentication means 2 will determine whether or not there is a match between the value of each character of the text string up to the input characters A and the first A characters of a registered administrator password (S6).

If there is a match in step S6, the process will move to step S1, and a determination will be made as to whether or not a character has been input from the input device 1 (S6 to S1).

If there is no match in step S6, the input acceptance/rejection means 5 will initiate, and an acceptance or rejection of the input of the next character will be randomly set (e.g., a probability of 50% that an input will be made) (S7).

When the acceptance or rejection of the input of the next character is randomly set during step S7, the authentication means 2 will determine whether or not the input of the next character is possible (S8). If the input of the next character is possible, the process will move to step S1 to determine whether or not a character has been input from input means 1, and if entry of the next character is not possible, it will be determined whether or not the number of input characters A is equal to the number of characters n in a registered user password (S9).

If it is determined in step S9 that the number of input characters A is equal to the number of characters n in a registered user password, it will be determined whether or not the value of each character of the text string matches each character of a registered user password (S10).

If there is a match in step S10, authentication as a user will be successful and user processes will be enabled in the image forming device 20 (S11).

In addition, if there is no match in step S10, the authentication means 2 will determine whether or not the values of each character in the text string match a registered administrator password (S10 to S12).

If the value of the each character of the text string matches each character of a registered administrator password in step S12, authentication as an administrator will be successful, and administrator processes will be enabled in the image forming device 20 (S13).

In addition, if there is no match in step S12, the password authentication process will be terminated.

Note that if it is determined that an input has not been made in step S1 and A is not equal to 0, i.e., if a second or subsequent character has not been input, the input completion means 4 will determine whether or not the predetermined amount of time that was pre-set in the timer of the input completion means 4 has lapsed (S14).

If the predetermined time has not lapsed in step S14, the process will move to step S1, where it will be again determined whether or not a character has been input from the input means 1. If the predetermined time has lapsed, the process will move to step S10, and the identical process noted above will be performed.

Note that in the aforementioned embodiment, a configuration has been described in which the input completion means 4 starts each time a character is input after the first character. However, instead of this configuration, a configuration is also possible in which the input completion means 4 is started each time a character is input beyond the number of characters in a registered user password.

Thus, by determining whether or not the value of each character in a text string matches the value of each character of a registered password each time a character of the text string is input, and randomly accepting or rejecting input of the next character when there is no match, it will be difficult for a person to guess a registration password.

In addition, in the aforementioned embodiment, only a single registered password may be stored in the authentication means. Furthermore, if for example the predetermined number of characters is 3 for a 5 character registered password, and a fourth or subsequent character in a text string is input, the input acceptance/rejection means and the input completion means may initiate each time one character is input.

In addition, the digital device is not restricted to an image forming device, and may for example be an information processing device such as a personal computer. In this case, the input means may for example be a keyboard, and an output means may for example be a monitor.

By determining whether or not a text string matches a registered password each time a character of the text string is input, and randomly accepting or rejecting input of the next character when there is no match, it will be difficult for a person to guess a registered password.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A password authentication device for authenticating the identity of a person attempting to use a digital device, comprising:
authentication means that compares a text string input from input means with a plurality of registered passwords in order to perform authentication, and determines, each time one character of the text string is input, whether or not the text string matches one of the plurality of registered passwords; and
input acceptance/rejection means which will allow input of the next character of the text string from the input means if the authentication means identifies a match, and which will randomly determine whether to accept or reject input of the next character in the text string from the input means if the authentication means does not identify a match.

2. The password authentication device according to claim 1, wherein the input acceptance/rejection means will be activated each time a character is input after a predetermined number of characters have been input.

3. The password authentication device according to claim 1, further comprising input conclusion means that will measure the input time from the point at which each character of the text string is input until the point at which the next character is input, and that will recognize that the input of the text string is complete when the input time is equal to or greater than a predetermined period of time.

4. The password authentication device according to claim 3, wherein the input conclusion means will be activated each time a character is input after a predetermined number of characters have been input.

5. The password authentication device according to claim 3, wherein the input conclusion means will be activated each time one character of the text string is input.

6. The password authentication device according to claim 1, wherein the authentication means will determine whether or not the number of characters in a text string has reached a predetermined maximum permitted number of characters.

7. The password authentication device according to claim 1, wherein at least one of the plurality of registered passwords is a user password having a predetermined number of characters.

8. The password authentication device according to claim 7, wherein at least one of the plurality of registered password is an administrator password having a level of authority that is different than that of the user password, and each administrator password comprises a first password having the same predetermined number of characters as the user password and a second password appended to the first password having a different predetermined number of characters than that of the user password.

9. A storage medium for storing an authentication program which is executed by a computer in which a password authentication device is provided, the authentication program causing the computer to function as:
authentication means that compares a text string input from input means with a plurality of registered password in order to perform authentication, and determines, each time one character of the text string is input, whether or not the text string matches one of the plurality of registered passwords; and
input acceptance/rejection means which allows input of the next character of the text string from the input means if the authentication means identifies a match, and which randomly determines whether to accept or reject input of the next character from the input means if the authentication means does not identify a match.

10. An authentication method performed in an authentication device, comprising the steps of:
comparing a text string input from an input means with a plurality of registered password in order to perform authentication, and determining, each time one character of the text string is input, whether or not the text string matches one of the plurality of registered passwords; and
allowing input of the next character of the text string from the input means if the authentication means identifies a match, and determining whether to accept or reject input of the next character from the input means if the authentication means does not identify a match.
